(19) United States
(12) Patent Application Publication
(10) Pub. No.: US 2012/0206378 A1
(43) Pub. Date: Aug. 16, 2012

(54) TOUCH DEVICE

(75) Inventor: Shih-Chieh Chen, Kaohsiung City (TW)

(73) Assignee: HANNSTAR DISPLAY CORPORATION, New Taipei City (TW)

(21) Appl. No.: 13/104,978

(22) Filed: May 11, 2011

(30) Foreign Application Priority Data
Feb. 15, 2011 (TW) 100104921

(51) Int. Cl. G06F 3/041

(52) U.S. Cl. 345/173

(57) ABSTRACT

A touch device is provided, which includes a touch display panel, a memory unit, and a processing unit. The memory unit is used to at least store both an operating system with a supporting touch function and a virtual mouse application program. The processing unit is coupled to the touch display panel and the memory unit and is used to operate the operating system and accordingly control the touch display panel to display an operation window. When the virtual mouse application program is executed by the processing unit in response to a command of a user, the virtual mouse application program generates a virtual mouse on the operation window, so as to allow the user to operate the virtual mouse through the touch display panel and thus achieve functions of a physical mouse.

### CROSS-REFERENCE TO RELATED APPLICATION

This application claims the priority benefit of Taiwan application serial no. 100104921, filed Feb. 15, 2011. The entirety of the above-mentioned patent application is hereby incorporated by reference herein and made a part of this specification.

### BACKGROUND OF THE INVENTION

1. Field of the Invention

The invention relates to a touch technology, more particularly, to a touch technology that can be applied to achieve functions of a physical mouse in a touch device.

2. Description of Related Art

With an advancement of electronic products, computer devices have become indispensable in our daily lives. In general, users control and operate the computer devices through human-machine interfaces, e.g., keyboards, mice, and so forth. Since the prevalent mice are equipped with the left key functions, the right key functions, and the scroll-up and scroll-down functions, users are able to proficiently control and operate the computer devices.

The progress of science and technology leads to integration of touch display panels into some of the computer devices (e.g., the tablet PCs) in replacement of the conventional keyboards and mice. As such, the users can directly operate the tablet PCs on the touch display panels. Unfortunately, even though the touch display panel serves as an intuitive operation human-machine interface, the operation of the touch display panel is not as convenient as that of the conventional physical mouse in some aspects.

For instance, in a tablet PC where a Microsoft windows operating system is installed and a touch display panel is integrated, when a user executes a “Microsoft Paint” application program” for illustration and editing, the touch display panel is rather difficult to use in comparison with the conventional physical mouse because the touch display panel does not have the left key function, the right key function, and the scroll-up and scroll-down functions. Additionally, users who are accustomed to the conventional physical mice may not be able to get used to the touch display panel.

### SUMMARY OF THE INVENTION

The invention is directed to a touch device that can resolve the issues described in the section of “Description of Related Art”.

In an embodiment of the invention, a touch device including a touch display panel, a memory unit, and a processing unit is provided. The memory unit is used to at least store both an operating system with a supporting touch function and a virtual mouse application program. The processing unit is coupled to the touch display panel and the memory unit and is used to operate the operating system and accordingly control the touch display panel to display an operation window. When the virtual mouse application program is executed by the processing unit in response to a command of a user, the virtual mouse application program generates a virtual mouse on the operation window, so as to allow the user to operate the virtual mouse through the touch display panel and thus achieve functions of a physical mouse.

According to an embodiment of the invention, the virtual mouse has an arrowhead index, a right key function, a left key function, a left key double-clicking function, a scroll-up function, and a scroll-down function.

According to an embodiment of the invention, the operating system at least includes a Windows 7 operating system (Win7 OS).

According to an embodiment of the invention, the touch display panel includes a capacitive touch display panel, a resistive touch display panel, an optical touch display panel, a surface acoustic wave (SAW) touch display panel, or an electromagnetic touch display panel.

According to an embodiment of the invention, the touch device at least includes a notebook computer, a tablet PC, or a smart phone.

Based on the above, a virtual mouse application program is designed/edited and stored in a touch device according to embodiments of the invention. When the processing unit of the touch device runs/executes the virtual mouse application program, the virtual mouse application program generates a virtual mouse on the operation window shown on the touch display panel in the touch device, and thereby a user can operate the virtual mouse through the touch display panel and thus achieve functions of a physical mouse. As such, the user who is used to operation of the conventional physical mice can also operate the touch device with ease.

Note that the above descriptions and the below embodiments are illustrative and exemplary and do not limit the scope of the invention.

### BRIEF DESCRIPTION OF THE DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a schematic view illustrating a touch device 10 according to an embodiment of the invention.

FIG. 2 is a schematic view illustrating an operation window 201 on a touch display panel 101 according to an embodiment of the invention.

FIG. 3A is a schematic view illustrating a step of activating a virtual mouse 205 according to an embodiment of the invention.

FIG. 3B is a schematic view illustrating a step of deactivating the virtual mouse 205 according to an embodiment of the invention.

### DESCRIPTION OF EMBODIMENTS

Descriptions of the invention are given with reference to the exemplary embodiments illustrated with accompanied drawings, wherein same or similar parts are denoted with same reference numerals. In addition, whenever possible, identical or similar reference numbers stand for identical or similar elements in the figures and the embodiments.

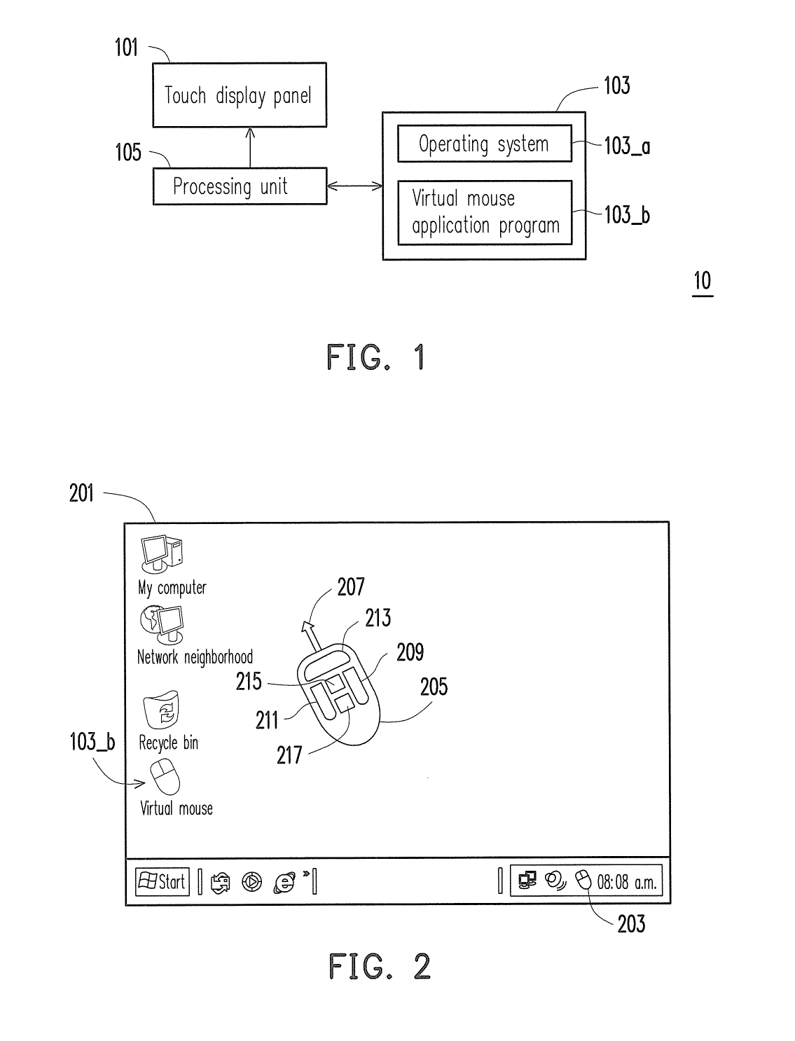

FIG. 1 is a schematic view illustrating a touch device 10 according to an embodiment of the invention. With reference to FIG. 1, the touch device 10 includes a touch display panel 101, a memory unit 103, and a processing unit 105. Certainly, the touch device 10 can further include other components (not shown), such as a wireless network module, an input/output (I/O) interface, an image capturing module, etc.

In this embodiment, the touch device 10 includes but is not limited to a notebook computer, a tablet PC, or a smart phone. Besides, the touch display panel 101 can be any type of the existing touch display panel, e.g., a capacitive touch display panel, a resistive touch display panel, an optical touch display panel, a surface acoustic wave (SAW) touch display panel, or an electromagnetic touch display panel.

The memory unit 103 is used to at least store a virtual mouse application program 103_{—}b and an operating system 103_{—}a with a supporting touch function. Here, the operating system 103_{—}a can be a Win7 OS, which should however not be construed as a limitation to the invention. Hence, the memory unit 103 can further store other application programs that are compatible with the Win7 OS.

The processing unit 105 is coupled to the touch display panel 101 and the memory unit 103 and is used to operate the operating system 103_{—}a and accordingly control the touch display panel 101 to display an operation window. When the virtual mouse application program 103_{—}b is executed by the processing unit 105 in response to a command/demand of a user, the virtual mouse application program 103_{—}b generates a virtual mouse on the operation window shown on the touch display panel 101, so as to allow the user to operate the virtual mouse through the touch display panel 101 and thus achieve functions of a physical mouse.

To be specific, FIG. 2 is a schematic view illustrating the operation window 201 on the touch display panel 101 according to an embodiment of the invention. With reference to FIG. 1 and FIG. 2, when the processing unit 105 executes the virtual mouse application program 103_{—}b in response to a command/demand of a user (i.e., when the user clicks the icon/the short cut of the “virtual mouse application program 103b” shown in the operation window 201 by a finger or via any other medium), the virtual mouse application program 103_{—}b becomes the resident program 203 of the operating system 103_{—}a.

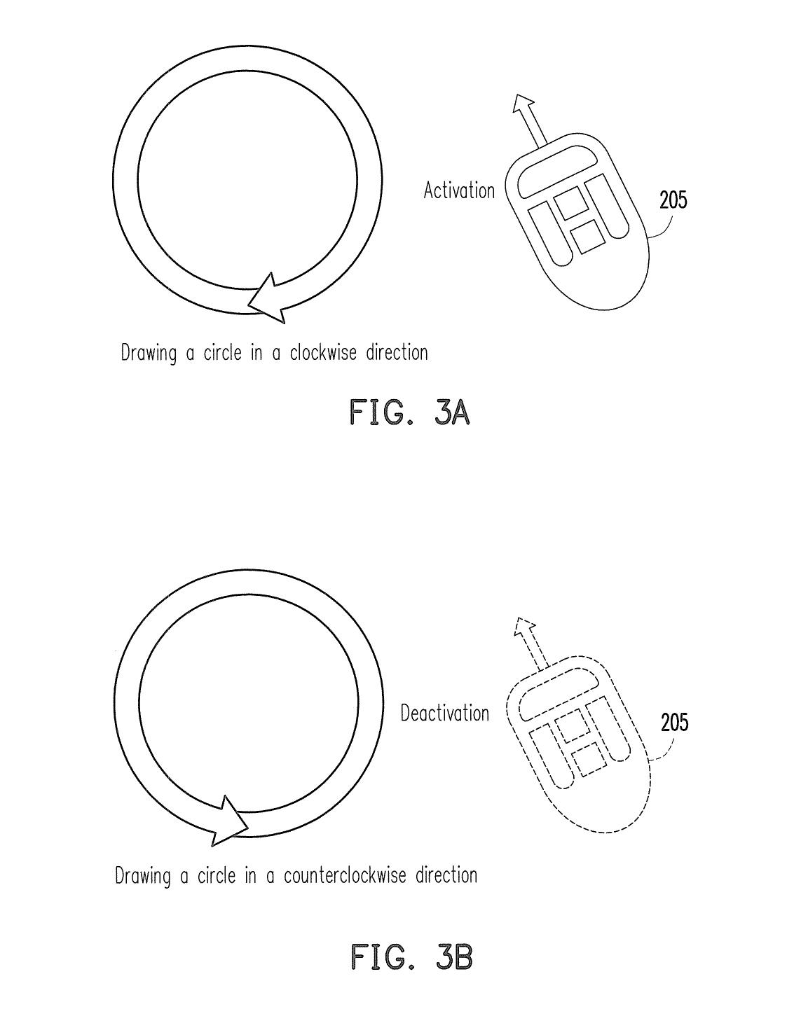

In this embodiment, after the virtual mouse application program 103_{—}b becomes the resident program 203 of the operating system 103_{—}a,the user can perform a first operation on the touch display panel 101, and then the virtual mouse 205 is activated and appears in the operation window 201, as shown in FIG. 3A. Here, the first operation includes but is not limited to drawing a circle in a clockwise direction. That is to say, the virtual mouse 205 is activated and appears in the operation window 201 when the user performs the first operation on the touch display panel 101.

By contrast, the user can perform a second operation on the touch display panel 101, and then the virtual mouse 205 is deactivated and disappears from the operation window 201, as shown in FIG. 3B. Here, the second operation includes but is not limited to drawing a circle in a counterclockwise direction. That is to say, the virtual mouse 205 is deactivated and disappears from the operation window 201 when the user performs the second operation on the touch display panel 101.

The virtual mouse 205 appearing in the operating system 201 upon the activation of the user can have an arrowhead index 207, a right key function 209, a left key function 211, a left key double-clicking function 213, a scroll-up function 215, and a scroll-down function 217. In addition, when the user clicks any location of the operation window 201 through the touch display panel 101, the arrowhead index 207 of the virtual mouse 205 immediately moves to the clicked location.

For instance, when the user clicks the icon of “My Computer” in the operating system 201 through the touch display panel 101, the arrowhead index 207 of the virtual mouse 205 immediately moves to the icon of “My Computer”. Alternatively, when the user clicks the icon of “Start” on the start menu in the operating system 201 through the touch display panel 101, the arrowhead index 207 of the virtual mouse 205 immediately moves to the icon of “Start” on the start menu. The clicking action and the reaction of the virtual mouse 205 can be deduced from the descriptions above and thus are not reiterated hereinafter. Thereby, the user can operate the virtual mouse 205 through the touch display panel 101 and further control the touch device 10.

In light of the foregoing, by operating the virtual mouse 205 on the touch display panel 101, the functions of the conventional physical mouse can be achieved in the touch device 10. As such, the operations of the touch device in which the Microsoft Windows OS is installed and the touch display panel is integrated can be performed with use of the conventional physical mouse, and thus even though the user who is accustomed to operate the desktop computer device with use of the conventional physical mouse, it is no longer difficult for the user to use such a touch device.

To sum up, a virtual mouse application program is designed/edited and stored in a touch device according to embodiments of the invention. When the processing unit of the touch device executes the virtual mouse application program, the virtual mouse application program generates a virtual mouse on the operation window of the touch display panel in the touch device, and thereby a user can operate the virtual mouse through the touch display panel and thus achieve functions of a physical mouse. As such, the user who is used to operation of the conventional physical mouse can also operate the touch device with ease.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions. Any of the embodiments or any of the claims of the invention does not need to achieve all of the advantages or features disclosed by the present invention. Moreover, the abstract and the headings are merely used to aid in searches of patent files and are not intended to limit the scope of the claims of the invention.

What is claimed is:

1. A touch device comprising:
a touch display panel;
a memory unit for at least storing both an operating system with a supporting touch function and a virtual mouse application program; and
a processing unit coupled to the touch display panel and the memory unit for operating the operating system and accordingly controlling the touch display panel to display an operation window, wherein when the virtual mouse application program is executed by the processing unit in response to a command of a user, the virtual mouse application program generates a virtual mouse on the operation window, so as to allow the user to operate the virtual mouse through the touch display panel and achieve functions of a physical mouse.

2. The touch device as claimed in claim 1, wherein when the processing unit executes the virtual mouse application program, the virtual mouse application program becomes a resident program of the operating system.

3. The touch device as claimed in claim 2, wherein when the user performs a first operation on the touch display panel, the virtual mouse is activated and appears in the operation window.

4. The touch device as claimed in claim 3, wherein when the user performs a second operation on the touch display panel, the virtual mouse is deactivated and disappears from the operation window.

5. The touch device as claimed in claim 4, wherein the first operation comprises drawing a circle in a clockwise direction, and the second operation comprises drawing a circle in a counterclockwise direction.

6. The touch device as claimed in claim 1, wherein the virtual mouse has an arrowhead index, a right key function, a left key function, a left key double-clicking function, a scroll-up function, and a scroll-down function.

7. The touch device as claimed in claim 6, wherein when the user clicks any location of the operation window through the touch display panel, the arrowhead index of the virtual mouse immediately moves to the clicked location.

8. The touch device as claimed in claim 1, wherein the operating system at least comprises a Windows 7 operating system.

9. The touch device as claimed in claim 1, wherein the touch display panel comprises a capacitive touch display panel, a resistive touch display panel, an optical touch display panel, a surface acoustic wave touch display panel, or an electromagnetic touch display panel.

10. The touch device as claimed in claim 1, wherein the touch device at least comprises a notebook computer, a tablet PC, or a smart phone.
